(19) United States
(12) Patent Application Publication
(10) Pub. No.: US 2009/0045647 A1
(43) Pub. Date: Feb. 19, 2009

(54) Apparatus and Method for Producing a Sun Shield Device

(76) Inventor: Carl E. Whitlock, Los Angeles, CA (US)

Correspondence Address: Law Office Of Robert E. Kasody,;Professional Corporation, 6601 Center Drive West, Suite #500, Los Angeles, CA, 90045, US

(21) Appl. No.: 11/840,037

(22) Filed: Aug. 16, 2007

(51) Int. Cl. B60J 3/00

(52) U.S. Cl. 296/97.9

(57) ABSTRACT

An apparatus for a vehicle window capable of an open, partially closed, and closed position. A screening layer substantially covers the vehicle window. The screening layer prevents ultra-violet light exposure of objects and occupants within the vehicle. In addition, a fastener attaches the screening layer about the vehicle window. The fastener substantially maintains the screening layer in a substantially similar position whether the vehicle window is in the open, the partially closed, or the closed position. A fragrance may be provided (within or a part of the screening layer) to reduce or eliminate odors for air flow into or out of the vehicle window.

### BACKGROUND OF THE INVENTION

1. Field of the Invention

The invention relates generally to sun visors mounted in vehicles and more particularly to an improved sun visor assembly.

2. Description of Related Technology

Conventional sun visor systems are designed to shield vehicle occupants from sunlight that enters a vehicle compartment through a windshield or a side window. In one instance, as exemplified by U.S. Pat. No. 6,923,490 to Peterson et al. entitled “Slidable Sun Visor Assembly” that issued in Aug. 2, 2005, a visor assembly includes a sliding visor body that has one or more frictional engagement surfaces that selectively engage to provide a sun shielding function. In another instance, as exemplified by U.S. Pat. No. 6,981,733 to Driscoll et al. entitled “Method for Blocking Glare from the Sun” issued Jan. 3, 2006, a plurality of rotating positionable blades are rotated to block sun glare. The plurality of rotating positionable blades attach to a vehicle visor, to a side window, or between the side window and the window weather stripping.

In yet another instance, as exemplified by U.S. Pat. No. 7,077,454 to Schambre entitled “Vehicle Sun Visor” issued on Jul. 18, 2006, a sun-visor is stored in a headliner of a vehicle and may be pulled out and pivoted downward to block light from an upper portion of a windshield. In yet another example, as exemplified by U.S. Pat. No. 7,216,917 to Tadakamalla entitled “Retractable Sun Visor and Full Windshield Cover” issued on May 15, 2007, a multi-function retractable sun shielding apparatus has a housing to receive and contain the retractable screen upon retracting the screen and a drive mechanism to deploy and retract the retractable screen. Still other conventional sun visors are placed on an inside of a windshield window and require a user to install the sun visor after each driving session and removed prior to again driving. Furthermore, such conventional sun visors need to be folded up or rolled up so as to require a storage location within the vehicle when not in use. Another conventional sun visor is one that installs on a window, e.g., side or rear window, with suction cups. This conventional sun visor does not cover the entire width of the window so are not designed to adequately protect an interior of the vehicle or occupants from sun damage and heat.

Other systems generally representative of sun visor apparatuses include, e.g., those described in U.S. Pat. No. 7,108,307 to Sahara et al. entitled “Vehicle Sun Visor Apparatus” issued Sep. 19, 2006; United States Patent Application Publication No. 2006/0214463 to Sahara et al. entitled “Vehicle Sun Visor Apparatus” published on Sep. 28, 2006; and United States Patent Application Publication No. US 2007/0028345 to McCarty entitled “Driving Sleeve (Tanless Driver) published on Feb. 8, 2007. In yet another examples, United States Patent Application Publication No. 2005/0017534 to Driscoll published on Jan. 27, 2005, and entitled “Method for Blocking Glare from the Sun and Apparatus therefor”, and United States Patent Application Publication No. 2005/0028948 to Austin published on Feb. 10, 2005, entitled “Sunshade for Vehicles.” Still other representative art include United States Patent Application Publication No. 2005/0073168 to Herrera entitled “Visor Gap Shade” published on Apr. 7, 2005, and United States Patent Application Publication No. 2005/0242610 to Galindo entitled “Vehicle Window Sun Cover” published on Nov. 3, 2005.

Still other representative art includes vehicle window screens such as U.S. Pat. No. 6,367,536 to St. Louis entitled “Vehicle Window Screen” including a window curtain (e.g., a net) having a shape generally conforming to the window opening that is hooked about the window opening of a vehicle. Other representative art for window screens or vehicle nets include U.S. Pat. No. 5,524,694 to Arapis entitled “Protective Screen for Vehicle Window”; U.S. Pat. No. 4,139,233 to Bott entitled “Screen for the Window at the top of the Vehicle Door”; U.S. Pat. No. 5,713,624 to Tower entitled “Retaining Net for Car Window”; and U.S. Pat. No. 3,960,195 to Marchbanks entitled “Ventilated screen for Motor Vehicle Passenger Compartment Window Openings”.

In summary, the related art includes sun shield for users to apply for use on a vehicle that involve complex mechanisms and user action to remove and/or place the sun shade or shield in an appropriate location to reduce glare and sun exposure. Furthermore, related art sun shields are generally a fixed size and provide limited coverage to vehicle occupants and an interior of the vehicle while stationary or in motion. Finally, vehicle window screens are generally limited to providing ventilation and preventing insects from entering a passenger compartment.

Thus, what are needed are apparatus and methods for sun shields that provide additional advantages over conventional systems. These advantages would include, inter alia, providing sun screening protection to occupants when a vehicle is in motion or stationary, providing sun screening both when the window is open or closed, and preventing objects from either entering or exiting an interior of a vehicle when it is in motion or stationary.

### SUMMARY OF THE INVENTION

In a first aspect of the present invention, an apparatus to provide sun screening is disclosed. In one embodiment, an apparatus is described for a vehicle window capable of an open, partially closed, and closed position. A sun screening layer is provided that substantially covers the vehicle window and prevent ultra-violet light exposure of objects and occupants within the vehicle. A fastener attaches the screening layer, in one example, to a door frame of a vehicle. The fastener substantially maintains the screening layer in a substantially similar position whether the vehicle window is in the open, the partially closed, or the closed position.

In a second aspect of the present invention, a system is disclosed for vehicle customization. In one embodiment of the present system, at least one semi-transparent material allows air flow into and out of the vehicle and to reduce exposure of at least one of objects and occupants within the vehicle to ultra-violet radiation from outside the vehicle. In this same embodiment, at least one mating structure attaches the at least one semi-transparent material to the vehicle. The attachment substantially covers at least one portion of a multi-position window of the vehicle and remains in a substantially similar position without regard to a position of the multi-position window.

In a third aspect of the present invention, a method is disclosed for reducing fading of objects and exposure of occupants to ultra-violet light through a vehicle window capable of at least one of an open and a closed position. In one embodiment, the method includes providing a custom-fitted ultra-violet rated screening material to substantially conform to a shape of the vehicle window, and providing one or more detachable structures to the custom-fitted ultra-violet rated screening material to a door periphery region of the vehicle to substantially cover at least a portion of the vehicle window. In one variant of this embodiment, the custom-fitted ultra-violet rated screen material remains in a substantially similar position whether the vehicle window is in the open or the closed position.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1 is a graphical illustration of a sun shield applied to a side window of a vehicle in accordance with an embodiment of the present invention.

FIGS. 2A, 2B, 2C, and 2D are graphical representations of various fasteners utilized for attachment of a sun shield to a side window of a vehicle in accordance with embodiments of the present invention.

FIG. 3 is a logical flow diagram illustrating a method for producing a sun shield for a vehicle in accordance with an embodiment of the present invention.

### DETAILED DESCRIPTION

Reference is now made to the drawings wherein like numerals refer to like parts throughout.

As used herein, the terms “sun shield” refers without limitation to any material, structure, or member that provides a level of protection to occupants, objects contained within vehicle, or an interior of a vehicle against radiation energy emitted radiation by a light source, e.g., Sun, such as material layer, vinyl screen, sun visor, plastic, mesh, multi-level plastic, multi-level metal mesh, multi-level cloth mesh, tinted plastic, composite material, PVC, cellophane, cloth mesh, screening material, stocking, nylon stocking, mat, or the like.

The term “vehicle” refers to without limitation to any means of transportation that allows occupants or objects therein to move from one location to another, such as automobile, truck, Sport Utility Vehicle (SUV), bus, train, or the like. Furthermore, the term “fastener” refers without limitation to any means of coupling, connecting, or mating the sun shield to one or more surfaces, structures, or devices, such as latch, loop, glue, epoxy, composite material, adhesive tape, Velcro (registered trademark), screw, button, slidable frame, gutter, slot, sliding member, slotted member, grooved member, frame member, window frame member, magnetic strip(s), corrugated frame, corrugated structure, symmetric array of perforations to interlock with the screening layer, asymmetric array or arrangement of perforations to interlock with the screening layer, or the like.

### Overview

In one salient aspect, the present invention discloses apparatus and method of providing, inter alia, a sun screening device for a vehicle. In particular, an apparatus is disclosed for a vehicle window capable of having more than one position, e.g., open, partially closed, and closed position. A screening layer substantially covers the vehicle window and prevents ultra-violet light exposure of objects and occupants within the vehicle. A fastener attaches the screening layer to an interior surface of a vehicle and substantially maintains the screening layer in a substantially similar position regardless of a position of the vehicle window, e.g., if the vehicle windows is in the open, the partially closed, or the closed position.

Broadly, the present invention generally provides a system and method for reducing fading of fabrics and objects. The system produced according to the present invention may also find beneficial use for reducing ultra-violet exposure of occupants within the vehicle, such as preventing or reducing the changes of skin cancer related to exposure to sun light. The system may also be useful for keeping objects from entering and exiting a vehicle while the vehicle is stationary as well as in motion. Additionally, the present invention may also be useful for customization of automobile as well as displaying logos and other signs, for instance, advertisement for businesses. Although the following discussion involves using a sun shield and fasteners as an exemplary demonstration, it is to be understood that this discussion is not limiting and that the present invention may be used in other suitable applications.

Conventional systems often require an individual to manually remove the sun shield before driving their vehicle (as well as installing within the window of their vehicle upon parking). However, in one embodiment, the system of the present invention may be installed on a door frame of vehicle interior that allows a user to maintain the sun shield in a substantially similar position whether their vehicle is in motion or a stationary position. Furthermore, conventional systems often require removal of the sun shield before objects may be sent though an opening in a window. However, in one embodiment, the system allows a user to accept objects as well as send objects outside of the window without removal of the sun screen. In one embodiment, an occupant of the vehicle maintains protection by the sun screen (e.g., its ultra violet protection properties as related to its rating level) whether the vehicle is or is not in motion. In one embodiment of the invention, no action is required on the behalf of an occupant to maintain the sun shield when a window of the door (having the sun shield) is opened or closed.

### Exemplary Apparatus—

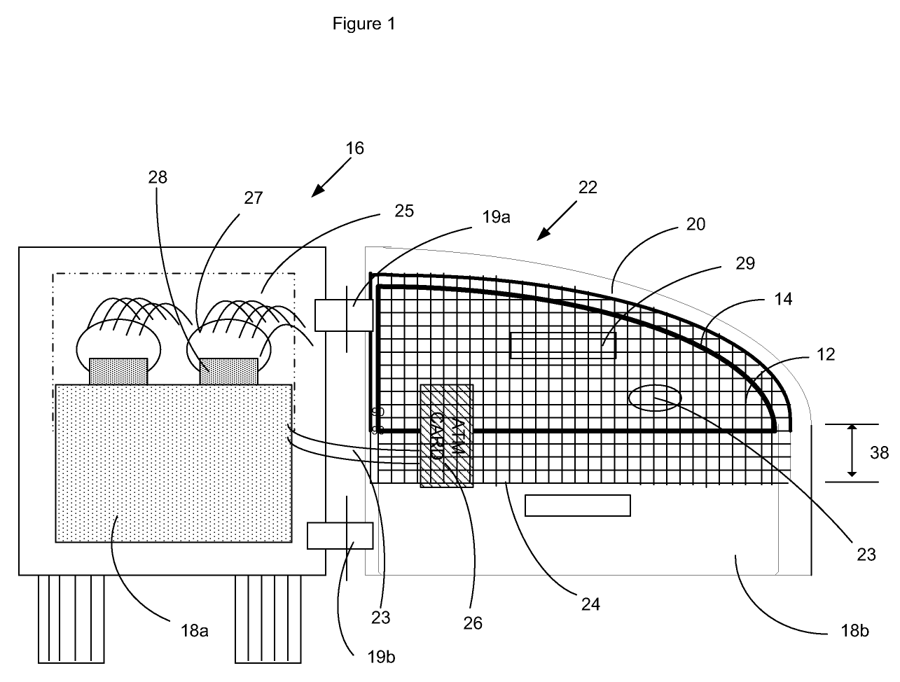

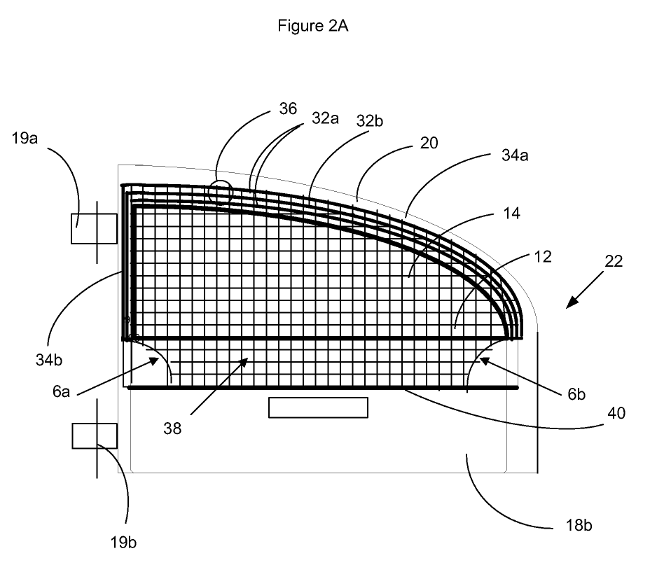

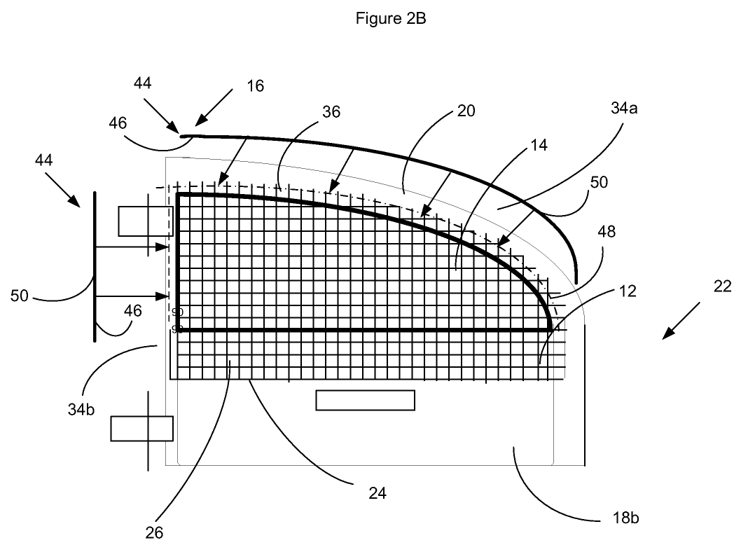

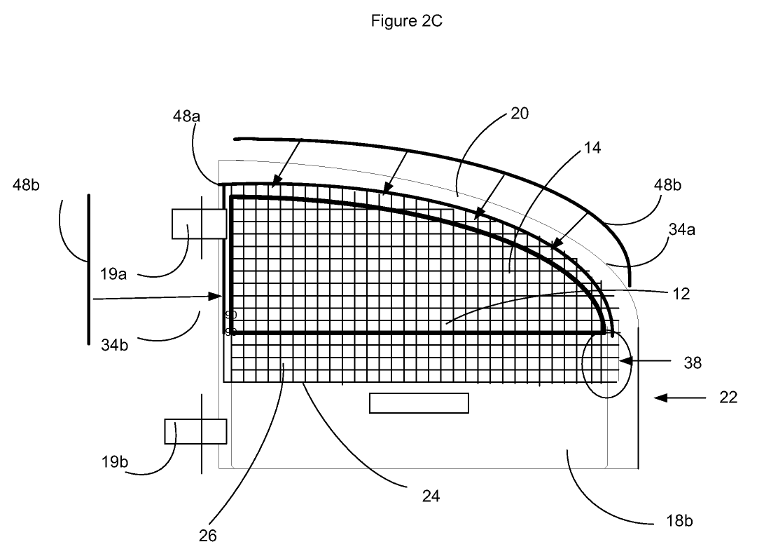

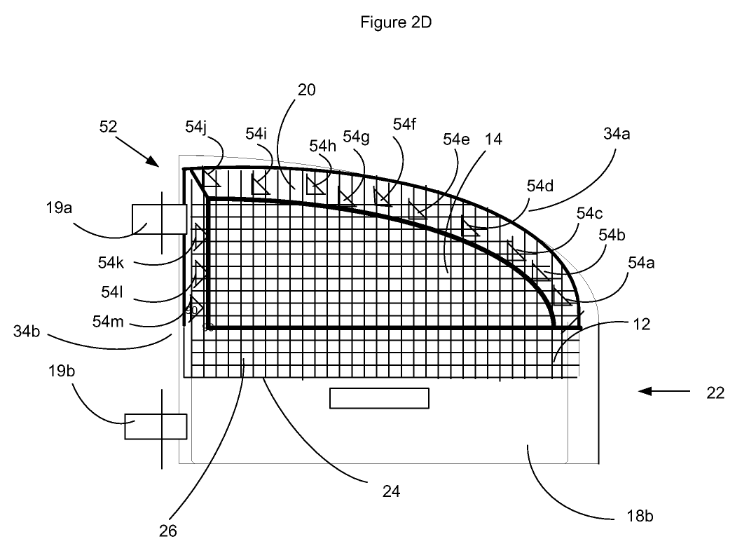

Referring now to FIGS. 1, 2A-D, exemplary embodiments of the sun visor system of the invention are described in detail. It will be appreciated that the invention will be described primarily in the context of providing sunlight protection to occupants and interior components of a vehicle, and to restrict generation of heat in the interior. For example, the present invention may prevent and/or reduce ultraviolet (UV) radiation from entering a vehicle interior; thus, interior components, e.g., of fabric, leather, or polymers such as plastics, may be prevented from degrading. Furthermore, the present invention may reduce an ambient temperature of a vehicle; thus, a vehicle's air conditioning efficiency may be improved as well as comfort associated with cooler seats and steering wheel. However, please note that this invention described herein may be used in other applications. Other applications may include unit packaging system that require light sensitive components such as transducers, sensors, and electrical and/or optical components within an assembly line process to be UV shielded while designated packaging operations are performed.

In addition, the present invention may find utility beyond purely as applied to a vehicle. For example, the sun visor system described subsequently herein may conceivably be utilized to improve other applications and systems; e.g., reducing glare and preventing ultra-violet radiation exposure of a computer screen to improve user viewing of the computer screen. Other functions might include module assembly (e.g., for purposes of providing ultra-violet screening while displaying electrical properties and measurement parameters during testing and/or operations before, during or after electronic module completion, and so forth). The present invention may also be utilized as a conduit for displaying a logo, advertisement, message, or other writing or display. Myriad of other functions will be recognized by those of ordinary skill in the art given the present disclosure.

Referring to FIG. 1, a graphical representation of a sun shield installed on a car side window is disclosed in accordance with an embodiment of the present invention. A sun screen, e.g., screening layer 12, is disposed on a window, e.g., side window 14, of a vehicle, e.g., automobile 16. The screening layer 12 may be a mesh layer, fully tinted layer, partially tinted layer, transparent layer, semi-transparent layer, a combination thereof or the like and allows partial or full air flow through its structure. Furthermore, the screening layer 12 may include one or more metal, polymer, or synthetic materials that are woven or sewn or attached together using glue, epoxy, or resin. In one variant, the screening layer 12 may have a design, logo, or advertisement. In another variant, the screening layer 12 may limit air flow from outside a vehicle, such as the automobile 16.

The side window 14, in this example, is capable of one of multiple positions. The multiple positions may include an open, partially closed, and closed position. In this embodiment, the screen layer 12 is fitted to substantially cover the side window 14. In one instance, the screening layer 12 is measured and cut to fit a particular window, such as side window 14. Consequently, the screening layer 12 may be part of a vehicle customization kit. Thus, the present invention allows a user to custom fit the screening layer 12 to a particular vehicle size whereas many conventional sun visors are produced in standard sizes, e.g., “one size fits all”. Thus, the present invention allows a user to more substantially protect an interior 18a, e.g. drivers and passengers seats, such as including fabric, leather, and plastics, whereas many conventional sun visors protect only a portion of the interior 18a due to their production in standard sizes where “one size fits all”.

As a result, the screening layer 12 has a potential to better protect an occupant, such as occupant 27, from sunlight damage, e.g., ultra-violet (UV) radiation, or objects, such as a component (e.g., headrest 28) within a vehicle, such the automobile 16. The screening layer 12 is attached within the automobile 16 proximately located, in this example, within an area of a frame 20 of a door 22. In one variant, the screening layer 12 may be attached proximate to a weather stripping (not shown) about a frame, frame 20, of the door 22. In another variant, the screening layer 12 may be installed along any surface or perimeter, e.g., a door periphery region, about a window, such as a side window 14. In another variant, as compared to a conventional sun visor, the screening layer 12 may be pulled back along an edge, e.g., edge 24. In one example, the edge 24 may be located about 2 to 4 inches below a lower portion of the side window 14 to prevent undesired motion (e.g., flapping) of the screening layer 12. Once pulled back, an object, such as Automatic Teller Machine (ATM) card 26, may be inserted through the screening layer 12, which in this example, the screening layer 12 is flexible. Thus, this present invention allows an occupant 27 to place an object, such as Automatic Teller Machine (ATM) card 26, behind the screening layer 12 and through the side window 14 to perform a function, e.g., conduct banking. Furthermore, an occupant 27 may smoke, for example, a cigarette in the automobile 16 and the smoke passes through the screening layer 12. In contrast, generally conventional sun visors would block smoke from passing and return the smoke back to an interior 18a of the automobile 16.

In one variant, the screening layer 12 may include a grid spacing 23 that may be adjusted, e.g., fine, medium, or course grid or any combination thereof, to control air flow, e.g., filter air, that passes through a window, e.g., such as the side window 14. In another variant, the screening layer 12 may include a fragrance. The fragrance may be sprayed on the screening layer, impregnated therein, or applied in one or more portion or strips, e.g., a fragrance portion 29. The fragrances, for example, may include rose, pine, wintergreen, mint, or the like. The fragrance may be utilized to reduce or remove odors in air flow entering and exiting the screening layer 12. Thus, the occupant 27 may choose a desired fragrance for air flow into and out of the side window 14.

Furthermore, in contrast to many conventional sun visor, the screen layer 12 remains in a substantially similar position whether a window, such as side window 14, is in the open, the partially closed, or the closed position. Thus, a similar level of sunlight protection, e.g., UV protection, is provided by the screening layer 12 whether the automobile 16 is or is not in motion. In contrast to the screening layer 12, conventional manually applied sun visors are installed when a vehicle, such as the automobile 16, is stationary to provide limited UV protection. However, to operate the automobile 16, a conventional manually applied sun visor has to be removed; thus, the conventional manually applied sun visor does not provide occupants or objects in a vehicle UV protection when the automobile 16 is in motion. Because the screening layer 12 attaches, in one embodiment, within a door periphery region, door jam, frame 20, or an inner surface of a door 22 (that revolves about hinges 19a and 19b) of the automobile 16, occupants of the automobile 16 may substantially freely exit and enter an automobile 16, through the door 22 without moving, adjusting, or relocating the screening layer 12. Thus, the present invention may save time and effort of an occupant, such as occupant 27, when entering or exiting the automobile 16.

Referring to an embodiment disclosed in FIG. 2A, a fastener 36 attaches the screening layer 12 to an interior surface 18b of a vehicle, such as automobile 16, along a door 22. The fastener 36 substantially maintains the screening layer 12 in a substantially similar position whether the vehicle window is in an open, partially closed, or closed position. In this embodiment, the fastener 30 comprises structures 32a, 32b. The structure 32a attaches to a portion of the frame of the door 22 of the vehicle, such as the automobile 16. The mating structure 32b detachably attaches the screening layer 12 to the frame 20 of the door 22. In this embodiment, the structure 32a may include a u-shaped plastic, metal, polycarbonate, or combination thereof frame and the structure 32b is a mating insert that includes materials such as plastic, metal, polycarbonate, or combination thereof. In this example, the fastener 36 substantially detachably attaches along at least two edge portions 34a, 34b of the window, e.g., the side window 14, of the automobile 16. In one variant, a rod 40 may be inserted near an edge 24 to assist holding the screening layer 12 against the inner 18a of the vehicle. In yet another variant, cut-out sections (e.g., lips 6a, 6b), for example, may be provided on exterior edges of the screening layer 12. These cut-out sections provide an unexpected advantage of preventing movement (e.g., flapping) of the screening layer 12 when the automobile 16 is in motion.

Referring to an embodiment illustrated in FIG. 2B, the fastener 44 may include a mating structure having a sticky surface, such as an inner surface 46, to proximately attach along a perimeter, e.g. perimeter 48 indicated by dotted line, of the frame 20 of the side window 14. Further, a non-sticky surface, such as an exterior surface 50, substantially blends or camouflages the fastener 44 within an interior 18b, of the vehicle, such as the automobile 16. In yet another variant, the screening layer 12 may include a stretchable material. The stretchable material may be a polymer, plastic, metal mesh, plastic mesh, cellophane, or the like. The stretchable material is prepared to conform to a shape of the window, such as the side window 14, and to permit trimming. The trimming feature allows custom fitting of the screening layer 12 proximate to a perimeter, e.g., perimeter 48, of the window, such as side window 14. Furthermore, the stretchable material permits a user to, after application of the screening to a window, to readjust if the stretchable material becomes overstretched, due to wear or stretching.

As such, the present invention is applicable to a vehicle customization system such as where the screening material includes a semi-transparent material (that may or may not be tinted) to allow air flow into and out of the vehicle and to reduce exposure of at least one of objects and occupants (e.g., individuals) within the vehicle to ultra-violet radiation from outside the vehicle. In addition, a mating structure, such as fastener 36 in FIG. 2A, may be applied to attach the semi-transparent material to an interior surface 18b to substantially cover at least one portion of a multi-position window of the vehicle. In addition, the semi-transparent material remains in a substantially similar position without regard to a position of the multi-position window. Furthermore, the semi-transparent material may include on one or more portion tinting, advertisements, or screen cutouts to further customize a look to a user's taste or application.

Referring to an embodiment illustrated in FIG. 2C, the at least one mating structure, such as Velcro material (e.g., members 48a, 48b), mates at least one portion of the frame 20 of the vehicle. In this instance, the member 48a placed behind the screening layer 12 and the member 48b placed above the screening layer 12 mates (shown by arrows) for attaching the screening layer 12 to the frame 20. In yet another variant of this embodiment, the mating structure (e.g., members 48a, 48b) substantially detachably attaches along at least two edge portions (e.g. sides 34a, 34b) of the multi-position window of the vehicle to permit entry and exit of an object along at least one edge of the at least on semi-transparent material without removal of the at least on semi-transparent material 12. In one variant, portion 38 overlaps a portion of the interior 18b. Referring to an embodiment illustrated in FIG. 2D, members 54a-m protrude from the frame 52. The member 54a-m may be hooks, interlocking structures, or projections (for example a tack strip) that interlock within one or more portions of a grid of the screening layer 12. In one example, the frame 52 may be magnetic and attached along a frame 20 of the door 22. In yet another example, the frame 52 may include an adhesive (e.g., a tacking sticky surface) on one side to stick to the frame 20.

### Exemplary Method—

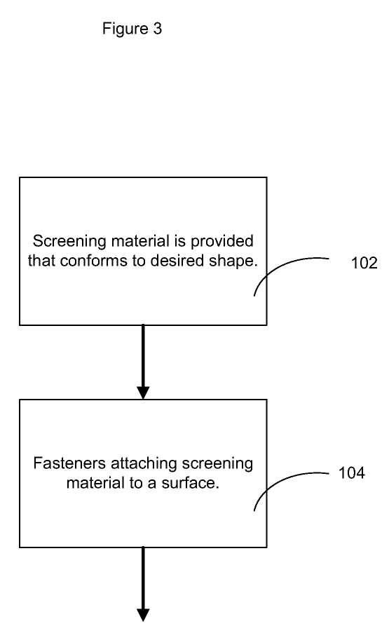

FIG. 3 is a logical flow diagram illustrating a method for producing a sun shield in accordance with an embodiment of the present invention. This method is based on components previously discussed in FIGS. 1 and 2A-2D. A user (not shown) desires to reduce fading of objects and exposure of occupants to ultra-violet light through a vehicle window capable of at least one of an open and a closed position. As shown in FIG. 2A, a custom-fitted ultra-violet rated screening material, e.g., screening layer 12, is provided to substantially conform to a shape of the window, e.g., the side window 14 (step 102). The screening layer 12 may include a fragrance portion 29 or be impregnated with a fragrance to modify an aroma of air flow into and out of the screening layer.

One or more detachable structures, e.g., the fasteners shown in FIG. 2A, to the custom-fitted ultra-violet rated screening material, e.g., the screening layer 12, to a frame 20 of the door 22 to substantially cover a portion of the window, e.g., the side window 14 (step 104). In one variant of step 104, the custom-fitted ultra-violet screen material, e.g., the screening layer 12 remains in a substantially similar position whether the vehicle, e.g., the automobile 16, is or is not in motion. In yet another variant of the step 104, the custom-fitted ultra-violet rated screening material, e.g., the screening layer 12, and the one or more detachable structures prevents objects from exiting from or entering into the vehicle while the vehicle 16 is in motion.

In still another variant, the one or more detachable structures, e.g., the fasteners shown in FIG. 2A comprise mating structures 32a, 32b mate to at least one portion of the vehicle, the automobile 16, to detachably attach the screening layer, e.g., the screening layer 12. In yet another variant of step 104, the custom-fitted ultra-violet rated screen material, e.g., the screening layer 12, remains in a substantially similar position whether the vehicle window, e.g., the side window 14, is in the open or the closed position. In yet another variant of step 104 (referring to FIG. 2B), the one or more detachable structures, e.g., fasteners shown in FIG. 2A, comprise a mating structure 44 having a sticky surface 46 attach proximately to a door peripheral region, the frame 20, or the door jam about the window and a non-sticky surface 50 that substantially blends, concealed, or camouflaged by the frame 20 and/or an interior 18b of the vehicle, e.g., the automobile 16. In an alternative of this variant, the custom-fitted ultra-violet rated screening layer comprises a stretchable material to conform to a shape of the window and to permit trimming of the custom-fitted ultra-violet rated screening layer to allow custom fitting proximate to a frame of the window.

In yet another variant of step 104 (referring to FIG. 2C), the one or more detachable structures comprise Velcro structures 48a, 48b that substantially detachably attaches along at least two edge portions 34a, 34b, of the vehicle window 14 and permits entry and exit of an object along at least one edge 24 of the custom-fitted ultra-violet rated screening material. In one variant, the custom-fitted ultra-violet rated screening material and the one or more detachable structures prevents objects from entering through the side window 14 even when the side window 14 is in the open position or partially open position regardless of motion of the vehicle. In another variant of step 104 (referring to FIG. 2D), member 52 including projections, e.g., tack stick members 54a-54m, to interlock with a portion of the screening layer 12. In one variant, the tack stick members 54a-54m are projections from a magnetic strip 52 that attaches to the door frame 20.

It is noted that many variations of the methods described above may be utilized consistent with the present invention. Specifically, certain steps are optional and may be performed or deleted as desired. Similarly, other steps (such as tinting, multi-mesh structures, multiple removals and resizing of the screening layer, or other mesh processing for example) may be added to the foregoing embodiments. Additionally, the order of performance of certain steps may be permuted, or performed in parallel (or series) if desired. Hence, the foregoing embodiments are merely illustrative of the broader methods of the invention disclosed herein.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. The foregoing description is of the best mode presently contemplated of carrying out the invention. This description is in no way meant to be limiting, but rather should be taken as illustrative of the general principles of the invention. The scope of the invention should be determined with the claims.

1. An apparatus for a vehicle window capable of an open, partially closed, and closed position comprising:
a screening layer to substantially cover the vehicle window and prevent ultra-violet light exposure of objects and occupants within a vehicle; and
a fastener to attach the screening layer to a door frame of the vehicle and to substantially maintain the screening layer in a substantially similar position whether the vehicle window is in the open, the partially closed, or the closed position.

2. The apparatus of claim 1, wherein the screening layer remains in a substantially similar position whether the vehicle is or is not in motion.

3. The apparatus of claim 1, wherein the fastener comprises a mating structure that mates to at least one portion of the door frame of the vehicle to detachably attach the screening layer.

4. The apparatus of claim 1, wherein the fastener comprises a mating structure that substantially detachably attaches along at least two edge portions of the vehicle window to permit entry and exit of an object along at least one edge of the screening layer without removal of the screening layer.

5. The apparatus of claim 1, wherein the screening layer and the fastener prevent objects from exiting into and out of the vehicle when the vehicle is in motion, and cutout sections are provided on exterior edges of the screening layer to prevent movement of the screening layer during motion of the vehicle.

6. The apparatus of claim 1, wherein the screening layer and the fastener prevent objects from entering through the vehicle window even when the vehicle window is in the open or the partially open position and whether or not the vehicle is in motion.

7. The apparatus of claim 1, wherein the fastener comprises a mating structure having a sticky surface to attach proximately about the vehicle window and a non-sticky surface that is substantially blended, concealed, or camouflaged within the door frame or an interior of the vehicle.

8. The apparatus of claim 1, wherein the screening layer comprises a stretchable material to conform to a shape of the vehicle window and to permit trimming to provide custom fitting of the screening layer proximately located within the door frame.

9. The apparatus of claim 1, wherein the screening layer provides ultra-violet protection to at least one of the objects or the occupants within the vehicle whether the window in the open, the partially closed, or the closed position and provides a fragrance for air flow through the vehicle window.

10. A vehicle customization system comprising:
at least one semi-transparent material to allow air flow into and out of a vehicle and to reduce exposure of at least one of objects and occupants within the vehicle to ultra-violet radiation from outside the vehicle; and
at least one mating structure to attach the at least one semi-transparent material within a door periphery region or door frame of the vehicle to substantially cover at least one portion of a multi-position window of the vehicle and remain in substantially a similar position without regard to a position of the multi-position window.

11. The system of claim 10, wherein the at least one mating structure mates to the door periphery region or the door frame of the vehicle to detachably attach the screening device.

12. The system of claim 10, wherein the at least one mating structure substantially detachably attaches along two portions of the multi-position window of the vehicle to permit entry and exit of an object along an edge of the at least one semi-transparent material without removal of the at least one semi-transparent material.

13. The system of claim 10, wherein the at least one semi-transparent material and the at least one mating structure prevents the objects from exiting or entering the vehicle when the vehicle is in motion.

14. The system of claim 10, wherein the at least one semi-transparent material and the at least one mating structure prevents objects from entering through the multi-position window even when the multi-position window is in a open or a partially open position and whether or not the vehicle is in motion.

15. The system of claim 10, wherein the at least one mating structure comprises a mating structure having a sticky surface to attach proximately along the door periphery region or the door frame about the multi-position window and a non-sticky surface that substantially blends or is camouflaged from view by the occupants.

16. The system of claim 10, wherein the at least on semi-transparent material comprises a stretchable material to conform a shape of the multi-position window and to permit trimming of the at least one semi-transparent material to allow custom fitting about the multi-position window.

17. The system of claim 10, wherein the at least one semi-transparent material provides ultra-violet protection to at least one of the objects or the occupants within the vehicle irrespective of a position of the multi-position window.

18. A method to reduce fading of objects and exposure of occupants to ultra-violet light (UV) through a vehicle window capable of at least one of an open and a closed position comprising:
providing a custom-fitted ultra-violet rated screening material to substantially conform to a shape of the vehicle window; and
providing one or more detachable structures to the custom-fitted ultra-violet rated screening material with a door periphery region or a door frame to substantially cover at least a portion of the vehicle window;
wherein the custom-fitted ultra-violet rated screening material remains in a substantially similar position whether the vehicle window is in the open or the closed position.

19. The method of claim 18, wherein the custom-fitted ultra-violet screen material remains in a substantially similar position whether the vehicle is or is not in motion, provides air filtering, and adds a fragrance to air as it passes through the custom-fitted ultra-violet screening material to reduce or eliminate odors passing through the vehicle window.

20. The method of claim 18, wherein the one or more detachable structures comprise a mating structure that mates to at least one portion of the door periphery region or the door frame to detachably attach the screening device to the vehicle; and
wherein the custom-fitted ultra-violet rated screen material and the one or more detachable structures prevents objects from exiting from or entering into the vehicle while the vehicle is in motion.

21. The method of claim 18, wherein the one or more detachable structures comprise a mating structure that substantially detachably attaches along at least two portions of the door periphery region or the door frame to permit entry and exit of an object along at least one edge of the custom-fitted ultra-violet rated screening material; and
wherein the custom-fitted ultra-violet rated screening material and the one or more detachable structures prevents the objects from entering through the vehicle window even when the vehicle window is in the open position or partially open position regardless of motion of the vehicle.

22. The method of claim 18, wherein the one or more detachable structures comprise a mating structure having has a sticky surface attached about the vehicle window and a non-sticky surface that is substantially blended within an interior of the vehicle or is camouflaged or hidden from view of the occupants; and
wherein the custom-fitted ultra-violet rated screening material comprises a stretchable material to conform to a shape of the vehicle window and to permit trimming of the custom-fitted ultra-violet rated screen layer to allow custom fitting proximate to a peripheral region of the vehicle window.

23. The method of claim 18, wherein the custom-fitted ultra-violet rated screening material provides ultra-violet protection to at least one of the objects or the occupants within the vehicle whether the vehicle window in the open, the partially closed, or the closed position and cut-out sections are provided on edges of the custom-fitted ultra-violet rated screening material proximate to an interior of the vehicle to prevent movement of the custom-fitted ultra-violet rated screening device when the vehicle is in motion.
